(19) United States
(12) Patent Application Publication
(10) Pub. No.: US 2025/0208639 A1
(43) Pub. Date: Jun. 26, 2025

(54) CONTROL CIRCUIT AND CONTROL METHOD OF VOLTAGE REGULATOR WITH LOAD LINE CALIBRATION

(71) Applicant: Chengdu Monolithic Power Systems Co., Ltd., Chengdu (CN)

(72) Inventors: Lijie Jiang, Hangzhou (CN); Fangyu Zhang, Hangzhou (CN); Wangmiao Hu, Hangzhou (CN); Keke Zhao, Hangzhou (CN)

(21) Appl. No.: 18/989,450

(22) Filed: Dec. 20, 2024

(30) Foreign Application Priority Data
Dec. 21, 2023 (CN) 202311778851.4

(51) Int. Cl. G05F 1/565; G05F 1/575

(52) U.S. Cl. CPC G05F 1/565; G05F 1/575

(57) ABSTRACT

A control circuit of a voltage regulator has an interface circuit, a reference circuit, a voltage positioning circuit, and a switching control circuit. The reference circuit provides a reference voltage based on a voltage setting data received by the interface circuit. The voltage positioning circuit provides a voltage positioning signal based on a voltage positioning data received by the interface circuit and an output current. The switching control circuit provides a plurality of switching control signals based on the reference voltage, the voltage positioning signal and an output voltage to control a plurality of switching circuits. The voltage positioning circuit calibrates the voltage positioning signal in response to the voltage positioning data.

### CROSS-REFERENCE TO RELATED APPLICATIONS

This application claims the benefit of Chinese Application 202311778851.4, filed on Dec. 21, 2023, and incorporated herein by reference.

### BACKGROUND OF THE INVENTION

### 1. Field of the Invention

The present invention generally refers to electrical circuits, and more particularly but not exclusively refers to control circuit and control method of voltage regulator.

### 2. Description of Related Art

In power supplies for microprocessors with high current and low voltage, the power performance, especially the transient response is vital. Adaptive voltage position (AVP) control is widely used to reduce voltage deviations of the output voltage (i.e., the power supply of microprocessors) during the load step to ensure the system stability.

The basic principle of traditional AVP control is shown in FIG. 1. An output voltage Vo decreases linearly from a voltage V1 to a voltage V2, as an output current Io (i.e. load current) increases from a minimum value (e.g., from zero) to a maximum load point Imax, wherein V1 may be a reference voltage set based on a voltage identification code (VID) from a processor load.

### SUMMARY OF THE INVENTION

It is an object of the present invention to provide a control circuit and a control method of a voltage regulator.

One embodiment of the present invention discloses a control circuit of a voltage regulator. The control circuit comprises an interface circuit, a reference circuit, a voltage positioning circuit, and a switching control circuit. The interface cirucit receives a voltage setting data and a voltage positioning data. The voltage setting data is used to control a set point of an output voltage of the voltage regulator. The voltage positioning data is used to control a slope of a load line, the load line shapes a relationship between the output voltage and an output current of the voltage regulator. The reference circuit is coupled to the interface circuit to receive the voltage setting data and provides a reference voltage based on the voltage setting data. The voltage positioning circuit is coupled to the interface circuit to receive the voltage positioning data, and provides a voltage positioning signal based on the voltage positioning data and the output current. The switching control circuit is coupled to the reference circuit and the voltage positioning circuit to receive the reference voltage and the voltage positioning signal respectively, and provides a plurality of switching control signals based on the reference voltage, the voltage positioning signal and the output voltage to control a plurality of switching circuits of the voltage regulator. The voltage positioning circuit is configured to calibrate the voltage positioning signal, ensuring that differences between the load line and a target load line defined by the voltage positioning data are within tolerances.

Another embodiment of the present invention discloses a control method of a voltage regulator. Receiving a voltage setting data and a voltage positioning data. The voltage setting data is used to control a set point of an output voltage of the voltage regulator. The voltage position data is used to control a slope of a load line, the load line shapes a relationship between the output voltage and an output current of the voltage regulator. Providing a feedback voltage based on the output voltage and providing a feedback current based on the output current. Providing a reference voltage based on the voltage setting data. Providing a voltage positioning signal based on the voltage positioning data and the feedback current. The output voltage deviates from the set point based on the voltage positioning signal. Providing a plurality of switching control signals based on the voltage positioning signal, the feedback voltage and the reference voltage, to turn ON and turn OFF a plurality of switching circuits of the voltage regulator. Calibrating the voltage positioning signal to match the load line with a target load line defined by the voltage positioning data.

Yet another embodiment of the present invention discloses a control circuit of a voltage regulator. The control circuit comprises a remote voltage sense pin and a remote voltage return pin coupled to sense an output voltage of the voltage regulator, a plurality of switching control pins configured to provide a plurality of switching control signals to control a plurality of switching circuits of the voltage regulator, a communication pin configured to receive a voltage positioning data, a differential amplification circuit, a current sense and process circuit, and a voltage positioning circuit. The differential amplification circuit is coupled to the remote voltage sense pin and the remote voltage return pin and configured to provide a feedback voltage at an output terminal based on the output voltage. The current sense and process circuit is configured to provide a feedback current indicative of an output current of the voltage regulator. The voltage positioning circuit is coupled to the current sense and process circuit to receive the feedback current and configured to provide a positioning current based on the feedback current. A voltage positioning signal is generated by the positioning current flowing through a voltage positioning resistor, and a resistance of the voltage positioning resistor is determined by the voltage positioning data. the voltage positioning circuit is configured to calibrate the voltage positioning signal in response to the voltage positioning data.

These and other features of the present invention will be readily apparent to persons of ordinary skill in the art upon reading the entirety of this disclosure, which comprises the accompanying drawings and claims.

### BRIEF DESCRIPTION OF DRAWINGS

The present invention can be further understood with reference to the following detailed description and the appended drawings, wherein like elements are provided with like reference numerals.

FIG. 1 shows a basic principle of a traditional adaptive voltage position (AVP) control.

FIG. 2 illustrates a block diagram of a voltage regulator 200 in accordance with an embodiment of the present invention.

FIG. 3A illustrates plots of a non-calibrated load line 301 and a target load line 302 in accordance with an embodiment of the present invention.

FIG. 3B illustrates plots of a calibrated load line 303 and the target load line 302 in accordance with an embodiment of the present invention.

FIG. 3C illustrates a process of calibrating the non-calibrated load line 301 to the calibrated load line 303 in accordance with an embodiment of the present invention.

FIG. 3D illustrates a process of calibrating the non-calibrated load line 301 to the calibrated load line 303 in accordance with another embodiment of the present invention.

FIG. 4 illustrates a circuit diagram of a voltage positioning circuit 103A in accordance with an embodiment of the present invention.

FIG. 5 illustrates a calibration register 50 in accordance with an embodiment of the present invention.

FIG. 6 illustrates a voltage positioning calibration method 600 of the voltage regulator 200 shown in FIG. 2 in accordance with an embodiment of the present invention.

FIG. 7 illustrates a circuit diagram of a switching control circuit 104A in accordance with an embodiment of the present invention.

FIG. 8 illustrates a circuit diagram of a voltage regulator 800 in accordance with an embodiment of the present invention.

FIG. 9 illustrates a circuit diagram of a switching circuit 82_1 in accordance with an embodiment of the present invention.

FIG. 10 illustrates a circuit diagram of a control circuit 81 in accordance with an embodiment of the present invention.

FIG. 11 illustrates a control method 900 of a voltage regulator in accordance with an embodiment of the present invention.

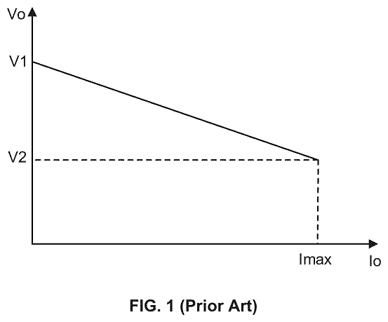

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

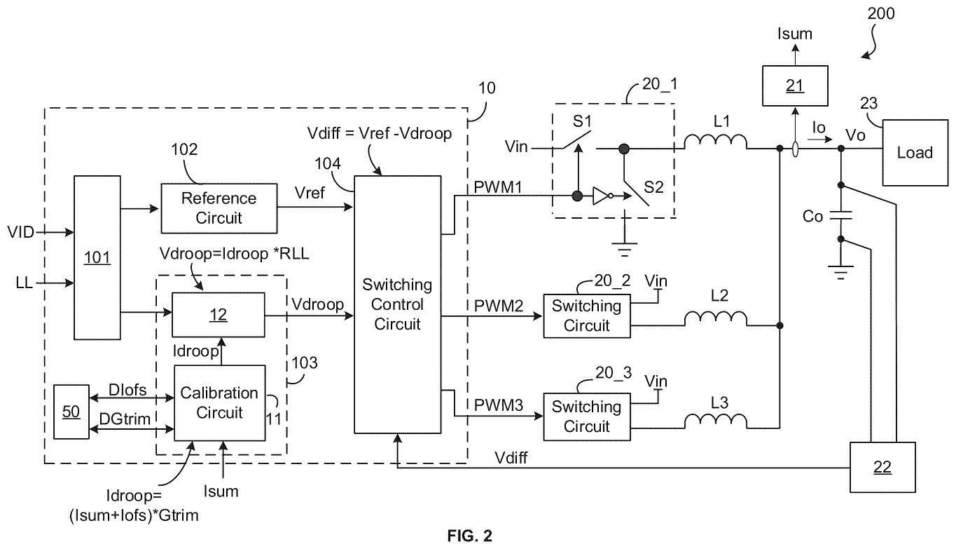

FIG. 2 illustrates a block diagram of a voltage regulator 200 in accordance with an embodiment of the present invention. The voltage regulator 200 receives an input voltage Vin, provides an output voltage Vo and an output current Io to a load 23. The Load 23 comprises, for example, processors such as central processing unit (CPU), graphics processing unit (GPU), etc. As shown in FIG. 2, the voltage regulator 200 comprises a control circuit 10, a plurality of switching circuits 20_1-20_3 connected in parallel between the input voltage Vin and the output voltage Vo, a plurality of output inductors L1-L3, and an output capacitor Co connected between the output voltage Vo and a reference ground. The control circuit 10 provides a plurality of switching control signals PWM1-PWM3 to control the plurality of switching circuits 20_1-20_3 (e.g., turn ON and turn OFF at least one switch in switching circuits 20_1-20_3), to convert the input voltage Vin to the output voltage Vo. For example, the switching control signal PWM1 is used to turn ON and turn OFF at least one switch in switching circuit 20_1, the switching control signal PWM2 is used to turn ON and turn OFF at least one switch in switching circuit 20_2, the switching control signal PWM3 is used to turn ON and turn OFF at least one switch in switching circuit 20_3. The output inductors L1-L3 are coupled between the switching circuits 20_1-20_3 and the output capacitor Co respectively. In one embodiment, the voltage regulator 200 further comprises a current sense circuit 21 and a voltage sense circuit 22. The current sense circuit 21 senses the output current Io and provides a feedback current Isum based on the output current Io. The current sense circuit 21 can be placed either inside or outside the control circuit 10. The voltage sense circuit 22 is coupled to both ends of the output capacitor Co and provides a feedback voltage Vdiff based on the output voltage Vo. The voltage sense circuit 22 comprises, for example, a differential sense circuit. The voltage sense circuit 22 can be placed either inside or outside the control circuit 10. The voltage regulator 200 shown in FIG. 2 has three switching circuits as one example. However, the voltage regulator 200 may have more or fewer than three switching circuits.

In the example of FIG. 2, the control circuit 10 comprises an interface circuit 101, a reference circuit 102, a voltage positioning circuit 103, and a switching control circuit 104. The interface circuit 101 receives a voltage setting data VID and a voltage positioning data LL. The voltage setting data VID is used to set a reference voltage Vref, so as to control a set point of the output voltage Vo, e.g., the output voltage Vo at a minimum output current. The voltage positioning data LL is used to control the slope of a load line, the load line shapes a relationship between the output voltage and the output current, e.g., a voltage droop of the output voltage Vo with increasing of the output current Io. The voltage setting data VID and the voltage positioning data LL, for example, can be provided by the load 23 or by a system controller. The reference circuit 102 provides the reference voltage Vref based on the voltage setting data VID. The voltage positioning circuit 103 provides the voltage positioning signal Vdroop based on the voltage positioning data LL and the output current Io (e.g., via the feedback current Isum), and the output voltage Vo deviates from the set point based on the voltage positioning signal Vdroop. The switching control circuit 104 provides the plurality of switching control signals PWM1-PWM3 based on the voltage positioning signal Vdroop, the output voltage Vo (e.g., via the feedback voltage Vdiff), and the reference voltage Vref.

In one example, the feedback voltage Vdiff equals the output voltage Vo, and the output voltage Vo satisfies the following equation (1), where RLL is a slope of the output voltage Vo varying with variation of the output current Io. The slope RLL is determined by the voltage positioning data LL. In one example, the slope RLL is a resistance of a voltage positioning resistor.

$$Vo = Vdiff = Vref - Vdroop = Vref = Io * RLL \qquad ( 1 )$$

Based on the equation (1), a curve regarding the output voltage Vo and the output current 10 can be obtained, which is the so-called load line curve. However, due to parasitic parameters and differences between ideal and reality of circuit components, the load line is different from a designed target load line. In particular, the differences between the ideal and reality value of the resistance of the voltage positioning resistor causes the load line deviating from the target load line. The calibration results for different slope RLL vary when calibrating the load line, which significantly increases the difficulty of load line calibration. Embodiments of the invention proposes the voltage positioning circuit 103 to calibrate the voltage positioning signal Vdroop in response to variations in the voltage positioning data LL, ensuring that differences between the load line and the target load line corresponding to the varied voltage positioning data are within tolerances. As a result, calibration of the voltage positioning signal Vdroop and the load line can be realized for any voltage positioning data LL. For example, calibrating an offset of the load line such that a difference between the output volage Vo at the minimum output current and the set point is within an offset tolerance, and calibrating a slope of the load line such that a difference between the slope RLL of the output voltage versus the output current 1o and a slope determined by the voltage positioning data LL is within a slope tolerance.

In the example of FIG. 2, the voltage positioning circuit 103 further comprises a calibration circuit 11 and a positioning generating circuit 12. The calibration circuit 11 provides a positioning current Idroop based on the feedback current Isum and an offset current Iofs. In one embodiment, the positioning current Idroop is equal to the product of an amplification coefficient Gtrim and a sum of the feedback current Isum and the offset current Iofs, as shown in equation (2).

$$Idroop = ( Isum + lofs ) * Gtrim \qquad ( 2 )$$

The calibration circuit 11 can get the positioning current Idroop corresponding to different voltage positioning data LL by adjusting the offset current Iofs and the amplification coefficient Gtrim, to realize the calibration of the voltage positioning signal Vdroop under any specific voltage positioning data LL. The positioning generating circuit 12 provides the voltage positioning signal Vdroop based on the positioning current Idroop and the voltage positioning data LL. For example, the voltage positioning signal Vdroop is equal to a voltage generated by the positioning current Idroop flowing through the voltage positioning resistor, as shown in equation (3).

$$Vdroop = ( Isum + lofs ) * Gtrim * RLL \qquad ( 3 )$$

In one example, the control circuit 10 further comprises a calibration register 50 for storing calibration parameters, e.g., an offset calibration data DIofs and a gain calibration data DGtrim, corresponding to the voltage positioning data LL. The offset calibration data DIofs is used to set the offset current Iofs, and the gain calibration data DGtrim is used to set the amplification coefficient Gtrim.

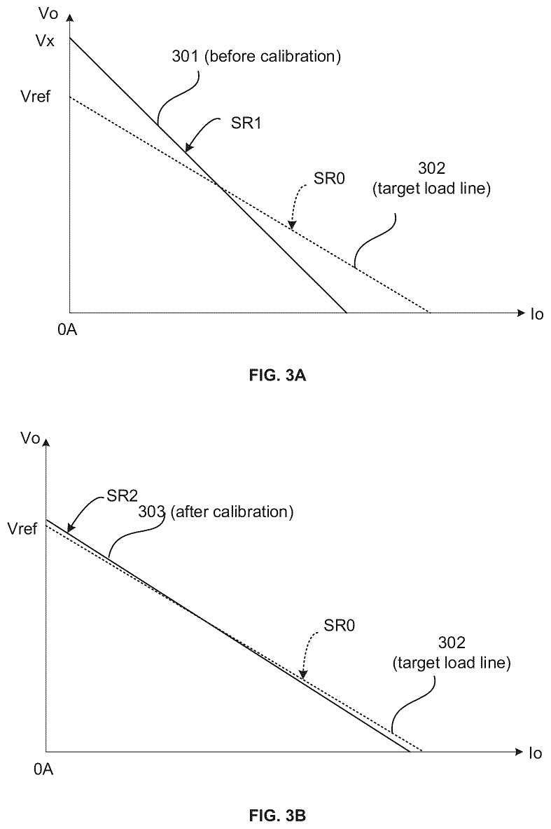

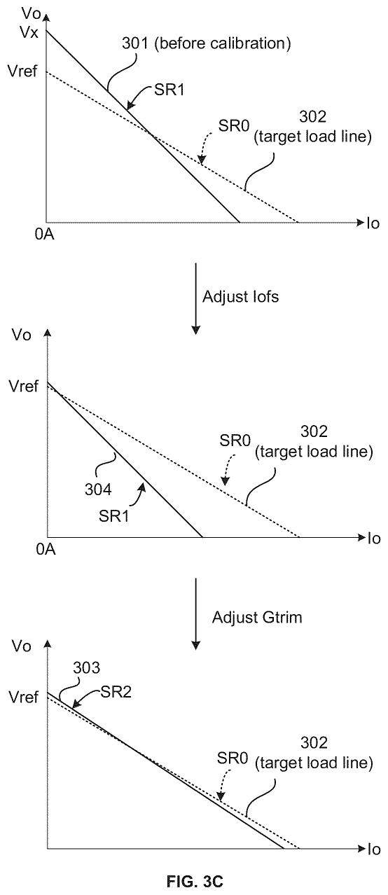

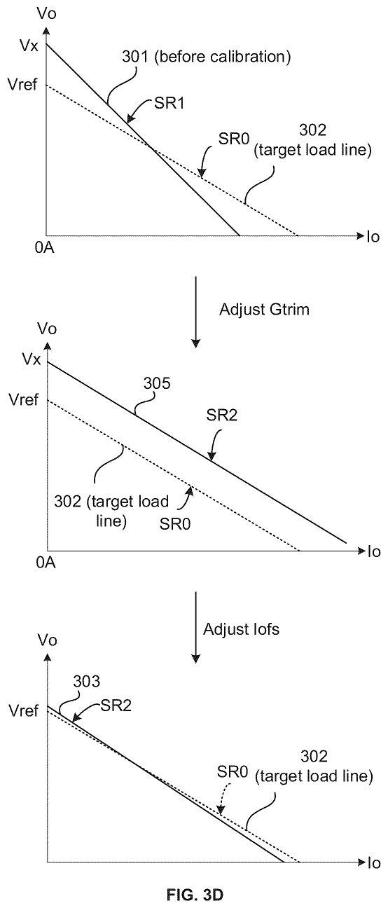

FIG. 3A illustrates plots of a non-calibrated load line 301 and a target load line 302 in accordance with an embodiment of the present invention. The horizontal axis represents the output current Io, and the vertical axis represents the output voltage Vo. In the example of FIG. 3A, the feedback voltage Vdiff equals the output voltage Vo. An offset of the target load line 302 is equal to the reference voltage Vref, that is the output voltage Vo at the minimum output current (e.g., Io=0A) should be equal to the reference voltage Vref, and a slope of the target load line 302 is SRO. The non-calibrated load line 301 is the load line before calibration. As shown in FIG. 3A, there is a large deviation between an offset Vx of the non-calibrated load line 301 and the offset Vref of the target load line 302, and there is a large deviation between the slope SR1 of the non-calibrated load line 301 and the slope SRO of the target load line 302.

FIG. 3B illustrates plots of a calibrated load line 303 and the target load line 302 in accordance with an embodiment of the present invention. The horizontal axis represents the output current Io, and the vertical axis represents the output voltage Vo. In the example of FIG. 3B, the feedback voltage Vdiff equals the output voltage Vo. As shown in FIG. 3B, after calibration, the calibrated load line 303 basically matches with the target load line 302. For example, an offset of the calibrated load line 303 is close to the offset Vref of the target load line 302, and the deviation between the offsets of the calibrated load line 303 and the target load line 302 can be accepted, for example, within the offset tolerance. The deviation between the slope SR2 of the calibrated load line 303 and the slope SRO of the target load line 302 can be accepted, for example, within the slope tolerance.

FIG. 3C illustrates a process of calibrating the non-calibrated load line 301 to the calibrated load line 303 in accordance with an embodiment of the present invention. In the embodiment shown in FIG. 3C, the non-calibrated load line 301 is calibrated to a load line 304 by adjusting the offset current Iofs such that the deviation between the offsets of load line 304 and the target load line 302 is within the offset tolerance. After that, the load lines 304 is calibrated to the calibrated load line 303 by adjusting the amplification coefficient Gtrim to further make sure the deviation between the slope SR2 of the calibrated load line 303 and the slope SRO of target load line 302 is within the slope tolerance.

FIG. 3D illustrates a process of calibrating the non-calibrated load line 301 to the calibrated load line 303 in accordance with another embodiment of the present invention. In the example shown in FIG. 3D, the non-calibrated load lines 301 is calibrated to a load line 305 by adjusting the amplification coefficient Gtrim, such that the deviation between the slope SR2 of the load line 305 and the slope SRO of the target load line 302 is within the slope tolerance. The offset current Iofs is then adjusted to calibrate the load lines 305 to the calibrated load line 303, such that the deviation between the offset of the calibrated load line 303 and the offset of the target load line 302 is within the offset tolerance.

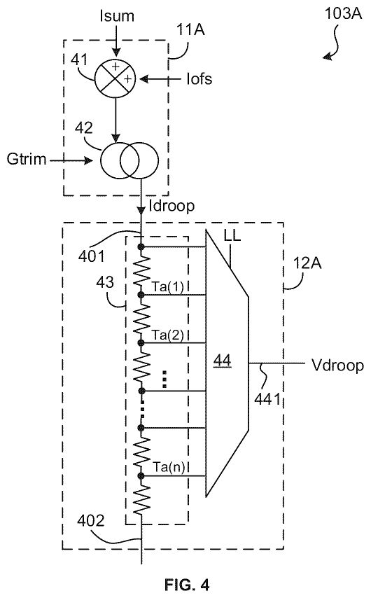

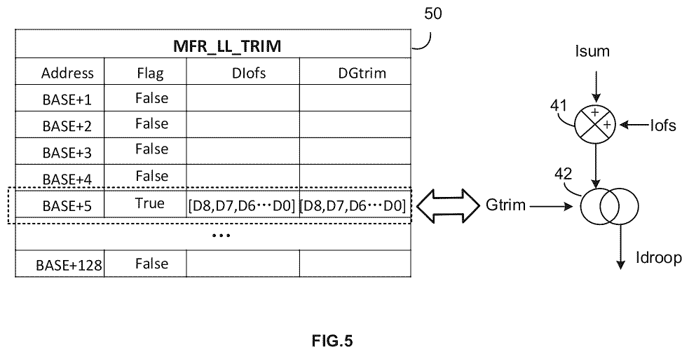

FIG. 4 illustrates a circuit diagram of a voltage positioning circuit 103A in accordance with an embodiment of the present invention. In the example of FIG. 4, the voltage positioning circuit 103A comprises a calibration circuit 11A formed by an offset circuit 41 and an amplification circuit 42, and a positioning generating circuit 12A formed by a resistance network 43 and a resistance control circuit 44.

The offset circuit 41 receives the feedback current Isum and the offset current Iofs and provides the sum of the feedback current Isum and the offset current Iofs (Isum+Iofs). The amplification circuit 42 provides the positioning current Idroop in response to the sum of the feedback current Isum and the offset current Iofs (Isum+Iofs). In one example, the amplification circuit 42 comprises a current mirror, which amplifies the sum of the feedback current Isum and the offset current Iofs (Isum+Iofs) by the amplification coefficient Gtrim.

The voltage positioning circuit 103A calibrates the positioning current Idroop by adjusting the offset current Iofs and the amplification coefficient Gtrim. The calibrated positioning current Idroop flows through the resistor network 43 to further calibrate the voltage positioning signal Vdroop, ensuring that the calibrated load line matches with the target load line desired by the voltage positioning data LL.

The resistance network 43 comprises a plurality of nodes Ta (1), Ta (2) . . . Ta (n), between two ends 401 and 402. The resistor network 43 could have different output resistance (i.e., the resistance RLL) by connecting different nodes. The resistance control circuit 44 has a plurality of input terminals coupled to the plurality of nodes of the resistance network 43 respectively. Based on the voltage positioning data LL, the resistance control circuit 44 selects one of the nodes of the resistance network 43 to control the resistance RLL of the voltage positioning resistor provided by the resistance network 43, to obtain the voltage positioning signal Vdroop. The voltage positioning signal Vdroop is equal to a voltage drop generated by the positioning current Idroop flowing through the voltage positioning resistor, i.e., Idroop*RLL. In one example, the resistor control circuit 44 comprises a selection circuit.

FIG. 5 illustrates a calibration register 50 in accordance with an embodiment of the present invention. In the example of FIG. 5, the calibration register 50 comprises a register MFR_LL_TRIM. For example, the register MFR_LL_TRIM has 128 sets of data for recording the calibration parameters corresponding to the resistance of a plurality of voltage positioning resistors. The calibration parameters are employed to calibrate the voltage positioning signal Vdroop. The register MFR_LL_TRIM may also have more or less than 128 sets of data, not limited by the example of FIG. 5. As shown in FIG. 5, each MFR_LL_TRIM (i) has address bits Address, a flag bit Flag, the offset calibration data DIofs, and the gain calibration data DGtrim. The address bits Address represents index of the voltage positioning data LL. For example, the address of MFR_LL_TRIM (i) is BASE+i, indicates that the corresponding voltage positioning data LL is equal to i, and the corresponding voltage positioning resistance RLL is equal to i*Rdroop. Rdroop is a minimum voltage positioning resistance value, and i is a natural number from 1 to 128. The Flag bit is used to indicate whether the voltage positioning resistor for a corresponding voltage positioning data LL has been calibrated. When the Flag data is “true” (e.g., “1”), it means that the voltage positioning resistor has been calibrated. Otherwise, when the Flag data is “false” (e.g., “0”), it means that the voltage positioning resistor has not been calibrated. The offset calibration data DIofs is used to control the offset current Iofs for the corresponding voltage positioning data LL. The gain calibration data DGtrim is used to control the amplification coefficient Gtrim for the corresponding voltage positioning data LL.

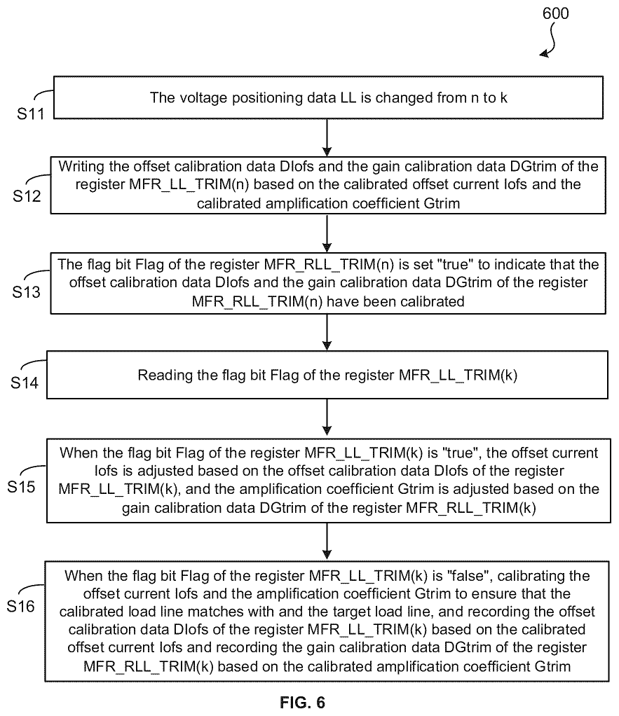

FIG. 6 illustrates a voltage positioning calibration method 600 of the voltage regulator 200 shown in FIG. 2 in accordance with an embodiment of the present invention. The voltage positioning calibration method 600 comprises steps S11-S16.

In step S11, the voltage positioning data LL received by the voltage regulator 200 is changed from n to k. In step S12, writing the offset calibration data DIofs and the gain calibration data DGtrim of the register MFR_LL_TRIM(n) based on the calibrated offset current Iofs and the calibrated amplification coefficient Gtrim. In step S13, the flag bit Flag of the register MFR_RLL_TRIM(n) is set “true” to indicate that the offset calibration data DIofs and the gain calibration data DGtrim of the register MFR_RLL_TRIM(n) have been calibrated. In step S14, reading the flag bit Flag of the register MFR_LL_TRIM(k). In step S15, when the flag bit Flag of the register MFR_LL_TRIM(k) is “true”, the offset current Iofs is adjusted based on the offset calibration data DIofs of the register MFR_LL_TRIM(k), and the amplification coefficient Gtrim is adjusted based on the gain calibration data DGtrim of the register MFR_RLL_TRIM(k). In step S16, when the flag bit Flag of the register MFR_LL_TRIM(k) is “false”, calibrating the offset current Iofs and the amplification coefficient Gtrim to ensure that the calibrated load line matches with the target load line, and recording the offset calibration data DIofs of the register MFR_LL_TRIM(k) based on the calibrated offset current Iofs and recording the gain calibration data DGtrim of the register MFR_RLL_TRIM(k) based on the calibrated amplification coefficient Gtrim. For example, adjusting the offset current Iofs and the amplification coefficient Gtrim based on the feedback current Isum and the feedback voltage Vdiff under at least two different load conditions.

Note that in the control methods described above, the functions indicated in the boxes can also occur in different orders than those shown in FIG. 6. Fox example, two boxes presented one after another can actually be executed essentially at the same time, or sometimes in reverse order, depending on the specific functionality involved.

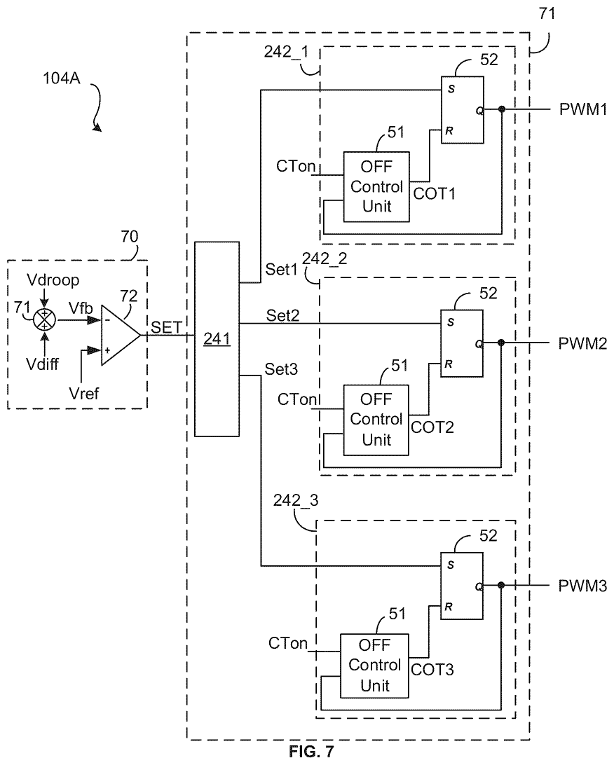

FIG. 7 illustrates a circuit diagram of a switching control circuit 104A in accordance with an embodiment of the present invention. The embodiment shown in FIG. 7 employs a constant ON-time control scheme as an example. In other embodiments, other suitable control scheme (e.g., peak current control) may be employed instead of the constant ON-time control. In the example of FIG. 7, the switching control circuit 104A comprises a control signal generating circuit 70, a frequency dividing unit 241, and a plurality of pulse width modulation units 242_1-242_3. In one example, the frequency dividing unit 241 and the pulse width modulation units 242_1-242_3 are implemented by a digital control unit 71, such as a field Programmable gate Array (FPGA), a load programmable logic device (CPLD), an application specific integrated circuit (ASIC), a processor (CPU), etc.

The control signal generating circuit 70 provides an ON-control signal SET based on the feedback voltage Vdiff, the voltage positioning signal Vdroop, and the reference voltage Vref. For example, an operating circuit 71 provides a feedback signal Vfb based on the sum of the feedback voltage Vdiff and the voltage positioning signal Vdroop (Vdiff+Vdroop), and a comparison circuit 72 provides the ON-control signal SET via comparing the feedback signal Vfb with the reference voltage Vref. When the feedback signal Vfb is less than the reference voltage Vref, the ON-control signal SET becomes active (e.g., logic high) to turn ON at least one switching circuit. One with ordinary skill in the art should also understand that the comparison circuit 72 may be substitute by an error amplification circuit, to generate the ON-control signal SET based on a difference between the reference voltage Vref and the feedback signal Vfb (Vref-Vfb).

The frequency dividing unit 241 provides a plurality of set signals Set1-Set3 based on the ON-control signal SET to turn on the plurality of switching circuits 20_1-20_3 in sequence. The pulse width modulation units 242_1-242_3 receive the set signals Set1-Set3 and an ON-time signal CTon, provide pulse width modulation signals PWM1-PWM3 respectively. In one embodiment, each pulse width modulation unit turns on a switching circuit based on the corresponding set signal and turns off the switching circuit based on the ON-time signa CTon. For example, the pulse width modulation unit 242_1 provides the pulse width modulation signal PWM1 to turn on the switching circuit 20_1 based on the set signal Set1 and turn off the switching circuit 20_1 based on the ON-time signal CTon, pulse width modulation unit 242_2 provides the pulse width modulation signal PWM2 to turn on the switching circuit 20_2 based on the set signal Set2 and turn off the switching circuit 20_2 based on the ON-time signal CTon, and the pulse width modulation unit 242_3 provides the pulse width modulation signal PWM3 to turn on the switching circuit 20_3 based on the set signal Set3 and turn off the switching circuit 20_3 based on the ON-time signal CTon. In one embodiment, each pulse width modulation unit comprises an OFF control unit 51 and a flip-flop 52. Below illustrating the pulse width modulation unit 242_1 as an example. The pulse width modulation unit 242-2, 242-3 have the same circuit structure as the pulse width modulation unit 242_1. For the pulse width modulation unit 242_1, the OFF control unit 51 provides the OFF-control signal COT1 based on the ON-time signal CTon and the pulse width modulation signal PWM1, to control a time period during which the pulse width modulation signal PWM1 remains at a first state (e.g., logic high), so as to control an ON-time period of the switching circuit 20_1. The flip-flop 52 has a set terminal S, a reset terminal R, and an output terminal Q. The set terminal S of the flip-flop 52 receives the set signal Set1, the reset terminal R receives the OFF-control signal COT1, and the output terminal Q provides the pulse width modulation signal PWM1. The pulse width modulation signal PWM1 transitions to the first state based on the set signal Set1 to turn on the switching circuit 20_1, and the pulse width modulation signal PWM1 transitions to a second state (e.g., logic low) based on the OFF-control signal COT1 to turn off the switching circuit 20_1.

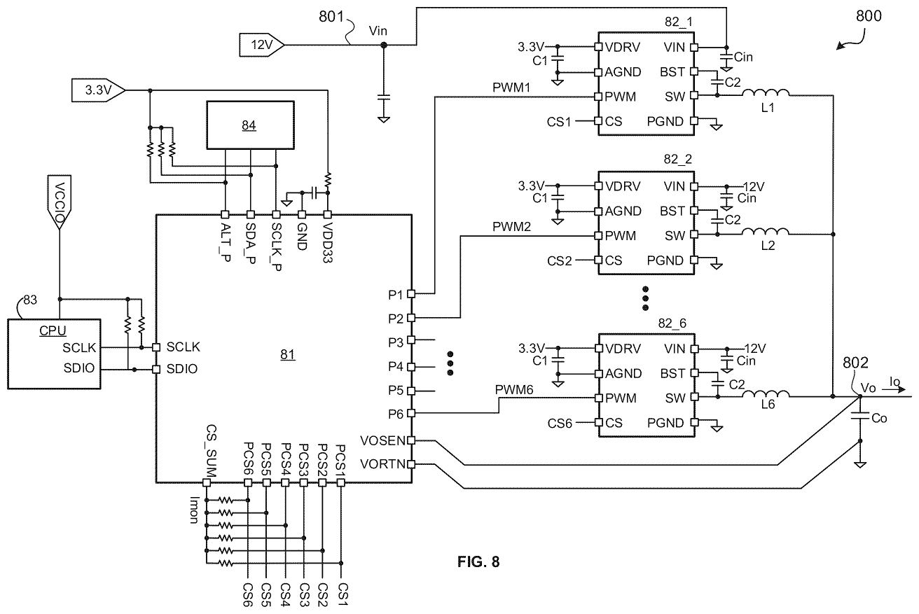

FIG. 8 illustrates a circuit diagram of a voltage regulator 800 in accordance with an embodiment of the present invention. The voltage regulator 800 comprises an input terminal 801, an output terminal 802, a control circuit 81, a plurality of switching circuits 82_1-82_6, a plurality of output inductors L1-L6, and an output capacitor Co. Each switching circuit associated with an output inductor forms a phase circuit. The voltage regulator 800 has six phase circuits as an example. However, one with ordinary skill in the art should understand that more or less phase circuits could be included in the voltage regulator 800. In the example of FIG. 8, the control circuit 81 is integrated on a control chip, and each switching circuit is integrated on a power chip.

As shown in FIG. 8, each power chip comprises a voltage input pin VIN coupled to the input terminal 801 to receive the input voltage Vin, a switch pin SW, a bootstrap pin BST, a logic power supply pin VDRV coupled to a logic power supply, a power reference ground pin PGND coupled to the reference ground, a signal reference ground pin AGND coupled to the reference ground, a current sense output pin CS, and a switching control input pin PWM. In one example, the input voltage Vin is 12V and the logic power supply is 3.3V. A coupling capacitor C1 is electrically connected between the logic supply pin VDRV and the signal reference ground pin AGND, a coupling capacitor C2 is electrically connected between the bootstrap pin BST and the switch pin SW, and a coupling capacitor Cin is electrically connected between the voltage input pin Vin and the reference ground. The switching control input pin PWM receives a corresponding switching control signal, and the current sense output pin CS provides a feedback signal representative of a current flowing through the corresponding switching circuit. For example, a feedback signal CS1 represents a current flowing through the switching circuit 82_1, a feedback signal CS2 represents a current flowing through the switching circuit 82_2, and so forth. A feedback signal CS6 represents a current flowing through the switching circuit 82_6. The switch pin SW coupled to the corresponding inductor to provide the output voltage Vo. For example, one end of the inductor L1 is coupled to the switch pin SW of the power chip where the switching circuit 82_1 is located at, and the other end of the inductor L1 is coupled to the output terminal 802. Similarly, one end of the inductor L6 is coupled to the switch pin SW of the power chip where the switching circuit 82_6 is located at, and the other end of the inductor L6 is coupled to the output terminal 802. The first end of the output capacitor Co is coupled to the output terminal 802, and the second end of the output capacitor Co is coupled to the reference ground.

The control chip comprises switching control pins P1-P6 for providing switching control signals PWM1-PWM6, phase current feedback pins PCS1-PCS6 for receiving feedback signals CS1-CS6, a total current feedback pin CS_SUM for receiving a total feedback current Imon, a remote voltage sense pin VOSEN, a remote voltage return pin VORTN. The remote voltage sense pin VOSEN is coupled to the first end of the output capacitor Co, and the remote voltage return pin VORTN is coupled to the second end of the output capacitor Co. In one embodiment, the control chip further comprises the communication pins SCLK and SDIO that can be coupled to the load 83 (e.g., a CPU) through the SVID bus (including a clock bus and a data bus). In the example of FIG. 8, the communication pin SCLK is coupled to the clock bus and the communication pin SDIO is coupled to the data bus. In one example, the control chip further comprises communication pins SCLK_P, SDA_P, and ALT_P that can be coupled to a system controller 84 through a PMBus (including the clock bus, the data bus, and an alert bus). In the example of FIG. 8, the communication pin SCLK_P is coupled to the clock bus, the communication pin SDA_P is coupled to the data bus, and the communication pin ALT_P is coupled to the alert bus. In one embodiment, the control chip further comprises a logic supply pin VDD33, which is coupled to the logic supply of 3.3V.

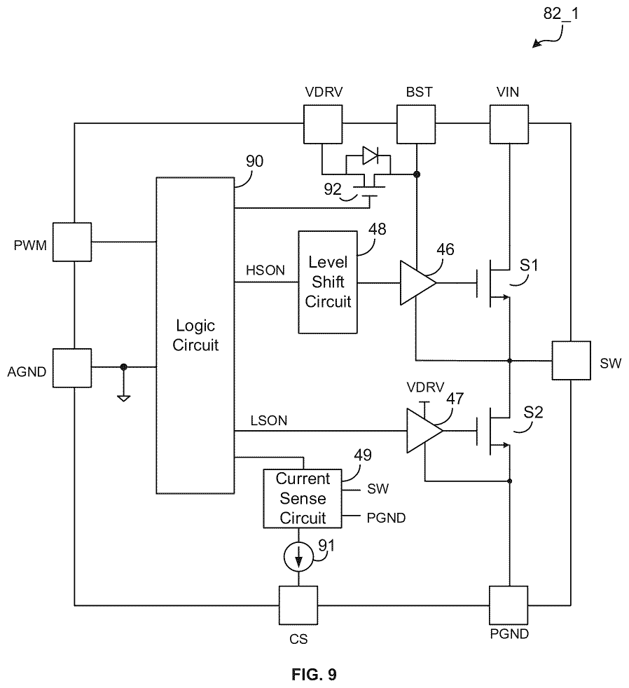

FIG. 9 illustrates a circuit diagram of a switching circuit 82_1 in accordance with an embodiment of the present invention. As shown in FIG. 9, the switching circuit 82_1 comprises a high-side switch S1 and a low-side switch S2. A first end of the high-side switch S1 is coupled to the voltage input pin VIN, a second end of the high-side switch S1 is coupled to the switch pin SW, and a control end of the high-side switch S1 is coupled to an output terminal of a driver 46. A first end of the low-side switch S2 is coupled to the switch pin SW, a second end of the low-side switch S2 is coupled to the power reference ground pin PGND, and a control end of the low-side switch S2 is coupled to an output terminal of a driver 47. The bootstrap pin BST is coupled to the logic power supply pin VDRV through a switch 92. A logic circuit 90 is coupled to the switching control input pin PWM and the signal reference ground pin AGND and provides a high-side switching control signal HSON and a low-side switching control signal LSON. The high-side switching control signal HSON is configured to control the high-side switch S1 through a level shift circuit 48 and the driver 46. The low-side switching control signal LSON is configured to control the low-side switch side switch S2 through the driver 47. A current sense circuit 49 senses a current flowing through the high-side switch S1 or the low-side switch S2, and provides a current sense signal at the current sense output pin CS. In one embodiment, a current source 91 is employed to convert the current sense signal into a current signal.

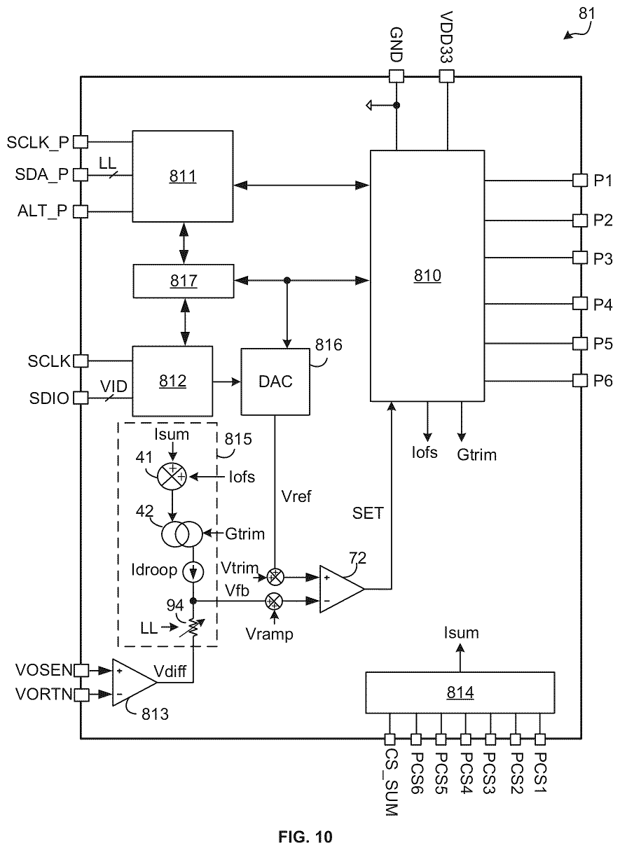

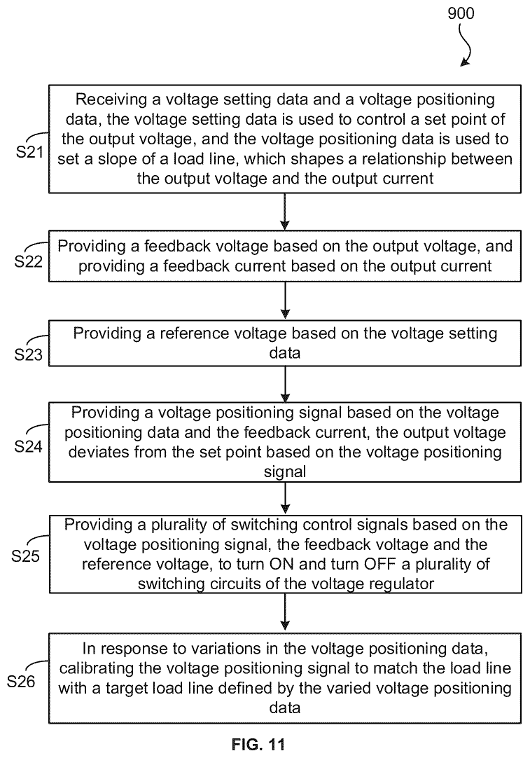

FIG. 10 illustrates a circuit diagram of a control circuit 81 in accordance with an embodiment of the present invention. As shown in FIG. 10, the control circuit 81 comprises a digital control unit 810, a differential amplification circuit 813, a current sense and process circuit 814, and a voltage positioning circuit 815. The digital control unit 810 provides switching control signals PWM1-PWM6 through switching control pins P1-P6. The remote voltage feedback pin VOSEN and the remote voltage return pin VORTN are coupled to input terminals of the differential amplification circuit 813 respectively. The differential amplification circuit 813 provides the feedback voltage Vdiff at its output terminal. The current sense and process circuit 814 is coupled to the phase current feedback pins PCS1-PCS6 and the total current feedback pin CS_SUM and provides the feedback current Isum based on the output current 10 of the voltage regulator 800. The offset circuit 41 provides the sum of the feedback current Isum and the offset current Iofs. The amplification circuit 42 amplifies the sum of the feedback current Isum and the offset current Iofs by the amplification coefficient Gtrim to obtain the positioning current Idroop at its output terminal. One end of a voltage positioning resistor 94 is coupled to the output terminal of the amplification circuit 42, and the other end of the voltage positioning resistor 94 is coupled to the output terminal of the differential amplification circuit 813. A voltage across the voltage positioning resistor 94 (i.e., the voltage positioning signal Vdroop) is generated by the positioning current Idroop flowing through the voltage positioning resistor 94. The voltage positioning signal Vdroop is superimposed with the feedback voltage Vdiff to generate the feedback signal Vfb. The feedback signal Vfb is obtained at one end of the voltage positioning resistor 94. In one embodiment, the resistance of the voltage positioning resistor 94 is controlled by the voltage positioning data LL. In one embodiment, in response to the variations in the voltage positioning data LL, the digital control unit 810 executes a voltage positioning calibration procedure to adjust the offset current Iofs and the amplification coefficient Gtrim. In one embodiment, the control circuit 81 generates the ON-control signal SET based on the feedback signal Vfb and the reference voltage Vref, for example, based on comparing the feedback signal Vfb with the reference voltage Vref, Or based on comparing the sum of the feedback signal Vfb and an output calibration signal Vtrim (Vfb+Vtrim) with the sum of the reference voltage Vref and a ramp signal Vramp (Vref+Vramp). The ramp signal Vramp is employed for improving stability of the voltage regulator 800, and the output calibration signal Vtrim is used to correct a DC static bias of the output voltage Vo.

In the example shown in FIG. 10, the control circuit 81 further comprises a PMBus interface circuit 811 and a VID interface circuit 812. The PMBus interface circuit 811 is coupled to the communication pins SCLK_P, SDA_P, and ALT_. The VID interface circuit 812 is coupled to the communication pin SCLK, and SDIO. In one embodiment, the PMBus interface circuit 811 receives the voltage positioning data LL, and the VID interface circuit 812 receives the voltage setting data VID. In another embodiment, the VID interface circuit 812 receives both the voltage positioning data LL and the voltage setting data VID. In one embodiment, the PMBus interface circuit 811 is coupled to the digital control unit 810 directly or through a memory 817. In one embodiment, the VID interface circuit 812 is coupled to the digital control unit 810 directly or through the memory 817. A digital-to-analog converter (DAC) 816 provides the reference voltage Vref based on the voltage setting data VID, the data stored in the memory 817, or the data sent by the digital control unit 810 through digital-to-analog conversion. The memory 817 comprises, for example, the register 50 as previously described.

FIG. 11 illustrates a control method 900 of a voltage regulator in accordance with an embodiment of the present invention, including steps S21-S26. The voltage regulator receives an input voltage and provides an output voltage and an output current to a load.

In step S21, receiving a voltage setting data and a voltage positioning data. The voltage setting data is used to control a set point of the output voltage, and the voltage positioning data is used to control the slope of a load line. The load line shapes a relationship between the output voltage and the output current, e.g., a voltage droop of the output voltage with increasing of the output current. In step S22, providing a feedback voltage based on the output voltage, and providing a feedback current based on the output current. In step S23, providing a reference voltage based on the voltage setting data. In step S24, providing a voltage positioning signal based on the voltage positioning data and the feedback current. The output voltage deviates from the set point based on the voltage positioning signal. In step S25, providing a plurality of switching control signals based on the voltage positioning signal, the feedback voltage and the reference voltage, to turn ON and turn OFF a plurality of switching circuits of the voltage regulator, to convert the input voltage to the output voltage. In step S26, in response to variations in the voltage positioning data, calibrating the voltage positioning signal to match the load line with a target load line defined by the varied voltage positioning data.

Note that in the control methods described above, the functions indicated in the boxes can also occur in different orders than those shown in FIG. 11. Fox example, two boxes presented one after another can actually be executed essentially at the same time, or sometimes in reverse order, depending on the specific functionality involved.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A control circuit of a voltage regulator, comprising:
an interface circuit configured to receive a voltage setting data and a voltage positioning data, wherein the voltage setting data is used to control a set point of an output voltage of the voltage regulator, and the voltage positioning data is used to control a slope of a load line, the load line shapes a relationship between the output voltage and an output current of the voltage regulator;
a reference circuit coupled to the interface circuit to receive the voltage setting data, and provides a reference voltage based on the voltage setting data;
a voltage positioning circuit coupled to the interface circuit to receive the voltage positioning data, and provides a voltage positioning signal based on the voltage positioning data and the output current; and
a switching control circuit coupled to the reference circuit and the voltage positioning circuit to receive the reference voltage and the voltage positioning signal respectively, and provides a plurality of switching control signals based on the reference voltage, the voltage positioning signal and the output voltage to control a plurality of switching circuits of the voltage regulator; wherein
the voltage positioning circuit is configured to calibrate the voltage positioning signal, ensuring that differences between the load line and a target load line defined by the voltage positioning data are within tolerances.

2. The control circuit of claim 1, wherein the voltage positioning circuit is configured to calibrate an offset of the load line such that a difference between the output voltage at a minimum output current and the set point is within an offset tolerance, and the voltage positioning circuit is configured to calibrate a slope of the load line such that a difference between a slope of the output voltage versus the output current and a slope determined by the voltage positioning data is within a slope tolerance.

3. The control circuit of claim 1, wherein the voltage positioning circuit further comprises:
a calibration circuit configured to provide a positioning current based on an offset current, an amplification coefficient, and a feedback current indicative of the output current, wherein the offset current and the amplification coefficient are adjusted to accommodate the voltage positioning data; and
a positioning generating circuit configured to provide the voltage positioning signal based on a voltage across a voltage positioning resistor that the positioning current flowing through, wherein a resistance of the voltage positioning resistor is controlled by the voltage positioning data.

4. The control circuit of claim 3, wherein the positioning current is equal to a product of the amplification coefficient and a sum of the feedback current and the offset current.

5. The control circuit of claim 1, wherein the voltage positioning circuit further comprises:
an offset circuit configured to provide a sum of an offset current and a feedback current indicative of the output current;
an amplification circuit configured to provide a positioning current by amplifying the sum of the feedback current and the offset current based on an amplification coefficient; and
a positioning generating circuit configured to provide the voltage positioning signal based on a voltage across a voltage positioning resistor that the positioning current flowing through, wherein a resistance of the voltage positioning resistor is controlled by the voltage positioning data.

6. The control circuit of claim 5, wherein the voltage positioning circuit is configured to calibrate the voltage positioning signal via adjusting the offset current and the amplification coefficient.

7. The control circuit of claim 1, further comprising:
a calibration register for storing calibration parameters corresponding to the voltage positioning data.

8. The control circuit of claim 7, wherein the calibration register further comprises:
address bits representative of index of the voltage positioning data;
a flag bit used to indicate whether a voltage positioning resistor for a corresponding voltage positioning data has been calibrated;
an offset calibration data used to control an offset current for the corresponding voltage positioning data; and
a gain calibration data used to control an amplification coefficient for the corresponding voltage positioning data.

9. A control method of a voltage regulator, comprising:
receiving a voltage setting data and a voltage positioning data, wherein the voltage setting data is used to control a set point of an output voltage of the voltage regulator, and the voltage position data is used to control a slope of a load line, the load line shapes a relationship between the output voltage and an output current of the voltage regulator;
providing a feedback voltage based on the output voltage, and providing a feedback current based on the output current;
providing a reference voltage based on the voltage setting data;
providing a voltage positioning signal based on the voltage positioning data and the feedback current, wherein the output voltage deviates from the set point based on the voltage positioning signal;
providing a plurality of switching control signals based on the voltage positioning signal, the feedback voltage and the reference voltage, to turn ON and turn OFF a plurality of switching circuits of the voltage regulator; and
calibrating the voltage positioning signal to match the load line with a target load line defined by the voltage positioning data.

10. The control method of claim 9, wherein calibrating the voltage positioning signal further comprising:
calibrating an offset of the load line such that a difference between the output voltage at a minimum output current and the set point is within an offset tolerance; and
calibrating a slope of the load line such that a difference between a slope of the output voltage varying with variation of the output current and a slope determined by the voltage positioning data is within a slope tolerance.

11. The control method of claim 9, further comprising:
providing a positioning current based on a product of an amplification coefficient and a sum of the feedback current and an offset current; and
providing the voltage positioning signal based on a voltage across a voltage positioning resistor through which the positioning current flowing through, wherein a resistance of the positioning resistor is controlled by the voltage positioning data.

12. The control method of claim 11, further comprising calibrating the voltage positioning signal via adjusting the offset current and the amplification coefficient.

13. The control method of claim 9, further comprising:
storing an offset calibration data and a gain calibration data in a register, wherein the offset calibration data is used to calibrate an offset of the load line, and the gain calibration data is used to calibrate a slope of the load line.

14. A control circuit of a voltage regulator, comprising:
a remote voltage sense pin and a remote voltage return pin coupled to sense an output voltage of the voltage regulator;
a plurality of switching control pins configured to provide a plurality of switching control signals to control a plurality of switching circuits of the voltage regulator;
a communication pin configured to receive a voltage positioning data;
a differential amplification circuit coupled to the remote voltage sense pin and the remote voltage return pin, and configured to provide a feedback voltage at an output terminal based on the output voltage;
a current sense and process circuit configured to provide a feedback current indicative of an output current of the voltage regulator; and
a voltage positioning circuit coupled to the current sense and process circuit to receive the feedback current and configured to provide a positioning current based on the feedback current, wherein a voltage positioning signal is generated by the positioning current flowing through a voltage positioning resistor, wherein a resistance of the voltage positioning resistor is determined by the voltage positioning data; wherein
the voltage positioning circuit is configured to calibrate the voltage positioning signal in response to the voltage positioning data.

15. The control circuit of claim 14, wherein the voltage positioning circuit further comprises:
an offset circuit configured to provide a sum of the feedback current and an offset current;
an amplification circuit configured to provide a positioning current by amplifying the sum of the feedback current and the offset current based on an amplification coefficient; and
a digital control unit configured to adjust the offset current and the amplification coefficient to calibrate the voltage positioning signal.

16. The control circuit of claim 14, wherein the voltage positioning resistor has a first end and a second end, the first end is coupled to receive the positioning current, and the second end is coupled to the output terminal of the differential amplification circuit, the first end of the voltage positioning resistor provides a sum of the voltage positioning signal and the feedback voltage.

17. The control circuit of claim 14, further comprising:
a calibration register for storing calibration parameters corresponding to the voltage positioning data.

18. The control circuit of claim 17, wherein the calibration register further comprises:
address bits representative of index of the voltage positioning data;
a flag bit used to indicate whether a voltage positioning resistor for a corresponding voltage positioning data has been calibrated;
an offset calibration data used to control an offset current for the corresponding voltage positioning data; and
a gain calibration data used to control an amplification coefficient for the corresponding voltage positioning data.

19. The control circuit of claim 14, wherein the voltage positioning circuit is configured to calibrate an offset of the load line such that a difference between the output voltage at a minimum output current and the set point is within an offset tolerance, and the voltage positioning circuit is configured to calibrate a slope of the load line such that a difference between a slope of the output voltage versus the output current and a slope determined by the voltage positioning data is within a slope tolerance.

20. The control circuit of claim 14, wherein the voltage positioning circuit further comprises:
an offset circuit configured to provide a sum of an offset current and a feedback current indicative of the output current; and
an amplification circuit configured to provide the positioning current by amplifying the sum of the feedback current and the offset current based on an amplification coefficient.
